(19) United States
(12) Patent Application Publication
(10) Pub. No.: US 2006/0277336 A1
(43) Pub. Date: Dec. 7, 2006

(54) Portable audio player with alternative operation interface and expanded function

(75) Inventors: Ming-Yao Lu, Taipei (TW); Shu-Ling Chen, Taipei (TW); Yung-Sung Chao, Taipei (TW); Jui-Hsiang Yang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Avermedia Technologies, Inc.

(21) Appl. No.: 11/213,469

(22) Filed: Aug. 26, 2005

(30) Foreign Application Priority Data
Jun. 2, 2005 (TW) 094118249

(51) Int. Cl. G06F 13/38

(52) U.S. Cl. 710/62

(57) ABSTRACT

A portable audio player includes a built-in operation interface for inputting a first command therefrom and generating a first control signal in response to the first command; a main circuit for processing and optionally storing audio data; and a microcontroller in communication with the built-in operation interface, the main circuit and an external operation interface for controlling the main circuit to process the audio data optionally in response to the first control signal or a second control signal generated by the external operation interface. The external operation interface may include a specific control program installed in a computer system, and the microcontroller may communicate with the external operation interface via a USB interface.

### FIELD OF THE INVENTION

The present invention relates to an audio player and more particular to a portable audio player such as MP3 or WMA player.

### BACKGROUND OF THE INVENTION

Nowadays, Universal Serial Bus (USB) has become the most popular transmission interface between a computer system and its peripheral equipments or associated electronic appliances such as printers, digital cameras, scanners, etc. Since USB devices have the advantages of plug-and-play feature and high transmission rate, all currently commercialized personal computers or notebook computers are equipped with USB interface slots. Some USB devices are further advantageous in portability. For example, a USB flash drive is quite compact in size while including a memory card of large storage capacity, so it is very convenient for a user to transfer data compared to conventional floppy discs and portable hard disc drives.

A MPEG Layer 3 player (MP3 player) is one of USB electronic appliances, which is capable of downloading and recording audio data from a personal computer or notebook computer via USB interface and generally outputting the recorded audio data via earphones. In addition to the recording function, a MP3 player may also serve as a tuner for receiving radio programs. The schematic functional block diagram of a common MP3 player is shown in FIG. 1. For playing, a microcontroller 100 reads digital audio data from a memory unit 101 which is typically implemented with a flash memory and then transmits the audio data to a decoder 102 to be converted into electronic signals. The electronic signals are then outputted via earphones 103. On the other hand, a tuner 105, after receiving and demodulating radio signals, may directly output the demodulated electronic signals to the earphones 103 to be played. Alternatively, the demodulated electronic signals can be processed into a digital audio compressed format by an encoder 106 and then stored into the memory unit 101. Afterwards, the data stored in the memory unit 101 may be read out and processed into electronic signals by the decoder 102 and outputted via the earphones 103. For recording or transferring data, the MP3 player communicates with a personal computer or notebook computer (not shown) via a USB interface 107 under the control of the microcontroller 100. The built-in memory of a currently commercialized MP3 player, similar to a common USB flash drive, has a large storage capacity up to 1 GB (gigabyte) but a compact size. Due to the compact size, a MP3 player generally has a small display 108, e.g. a liquid crystal display (LCD), and simplified operation interface 109. The microcontroller 100 controls the displaying of information via a display controller 104 in response to the command inputted through the operation interface 109.

Even though the storage capacity of the memory unit 101 of the MP3 player can be up to 1 GB, it may still be insufficient for recording radio programs that might take hours. Further, the functions of the MP3 player would be confined due to the small display and simplified operation interface. For example, it would be infeasible to search and memorize radio channels and has difficulty in variably tuning audio outputs with an equalizer.

### SUMMARY OF THE INVENTION

Therefore, the present invention provides an audio player with alternative operation interface and expanded functions. The present invention is particular beneficial to a portable audio player that has a limited number of actuation keys and a small display.

The present invention provides a portable audio player, which comprises a built-in operation interface for inputting a first command therefrom and generating a first control signal in response to the first command; a main circuit for processing and optionally storing audio data; and a microcontroller in communication with the built-in operation interface, the main circuit and an external operation interface for controlling the main circuit to process the audio data optionally in response to the first control signal or a second control signal generated by the external operation interface.

In an embodiment, the external operation interface is installed in a computer system. The microcontroller communicates with the external operation interface via a USB interface, for example. The external operation interface may include an input interface and a specific control program. For example, the input interface may include a display of the computer system, a graphics interface shown on the display under the control of the specific control program, and a keyboard or mouse device for manipulating the graphics interface therevia.

In an embodiment, the built-in operation interface includes at least one actuation key and a display.

In an embodiment, the built-in operation interface, main circuit and microcontroller are integrated to the same housing and optionally connect to the external operation interface via a USB connector.

In an embodiment, the main circuit comprises a non-volatile memory unit for storing first audio data in a digital form; an audio decoder coupled to the non-volatile memory unit and the microcontroller for converting the first audio data read from the non-volatile memory unit from the digital form into an audible form under the control of the microcontroller in response to the first or second control signal; and an earphone socket coupled to the audio decoder for playing the first audio data in the audible form.

In an embodiment, the microcontroller controls the audio decoder to differentially adjust gains of the first audio data at different frequency sections in response to the second control signal generated by the external operation interface.

In an embodiment, the main circuit comprises a tuner for receiving radio signals as second audio data and outputting the second audio data in an analog form; and an analog-to-digital converter coupled to the tuner and the microcontroller for converting the second audio data received from the tuner from the analog form into a digital form and transmitting the second audio data in the digital form to a computer system to be stored under the control of the microcontroller in response to the first or second control signal.

In an embodiment, the microcontroller controls the tuner to scan, search and/or memorize radio channels in response to the second control signal generated by the external operation interface.

In an embodiment, the microcontroller controls the analog-to-digital converter to store the second audio data into the computer system in a time-shift recording mode in response to the second control signal generated by the external operation interface.

In an embodiment, in the time-shift recording mode, the second audio data are played back to a designated time point that the playing of the second audio data were interrupted while the recording of the second audio data into a hard disc of the computer system are kept in real-time.

In an embodiment, the main circuit comprises a tuner for receiving radio signals as third audio data and outputting the third audio data in an analog form; an audio encoder coupled to the tuner and the microcontroller for converting the third audio data from the analog form into a digital form under the control of the microcontroller in response to the first or second control signal; and a non-volatile memory unit for storing the third audio data in the digital form, e.g. a digital audio compressed format such as MP3 or WMA format.

The present invention also provides an audio player for use with a computer system, which comprises a microcontroller communicable with the computer system via a USB interface; a built-in non-volatile memory unit for storing first audio data in a digital form; and an audio decoder coupled to the built-in non-volatile memory unit and the microcontroller for converting the first audio data read from the built-in non-volatile memory unit from the digital form into an audible form, and differentially adjusting gains of the first audio data at different frequency sections under the control of the microcontroller in response to a first control signal from the computer system.

In an embodiment, the audio player a further comprises a tuner for receiving radio signals as second audio data and outputting the second audio data in an analog form, wherein the microcontroller controls the tuner to scan, search and/or memorize radio channels in response to a second control signal from the computer system.

In an embodiment, the audio player a further comprises an analog-to-digital converter coupled to the tuner and the microcontroller for converting the second audio data received from the tuner from the analog form into a digital form, wherein the microcontroller controls the analog-to-digital converter to store the second audio data in the digital form into the computer system in a time-shift recording mode in response to a third control signal from the computer system.

The present invention further provides an audio player for use with a computer system, which comprises a microcontroller communicable with the computer system via a USB interface; a tuner for receiving radio signals as first audio data and outputting the first audio data in an analog form; and an analog-to-digital converter coupled to the tuner and the microcontroller for converting the first audio data received from the tuner from the analog form into a digital form and transmitting the first audio data in the digital form to a computer system to be stored under the control of the microcontroller in response to a first control signal.

In an embodiment, the audio player a further comprises an audio encoder coupled to the tuner and the microcontroller for converting the first audio data from the analog form into a digital audio compressed format under the control of the microcontroller in response to a second control signal from the computer system; a built-in non-volatile memory unit for storing the first audio data in the digital audio compressed format; and an audio decoder coupled to the built-in non-volatile memory unit and the microcontroller for converting the first audio data read from the built-in non-volatile memory unit from the digital audio compressed format into an audible form, and differentially adjusting gains of the first audio data at different frequency sections under the control of the microcontroller in response to a third control signal from the computer system.

### BRIEF DESCRIPTION OF THE DRAWINGS

The present invention may best be understood through the following description with reference to the accompanying drawings, in which:

FIG. 1 is a schematic functional block diagram showing a conventional MP3 player;

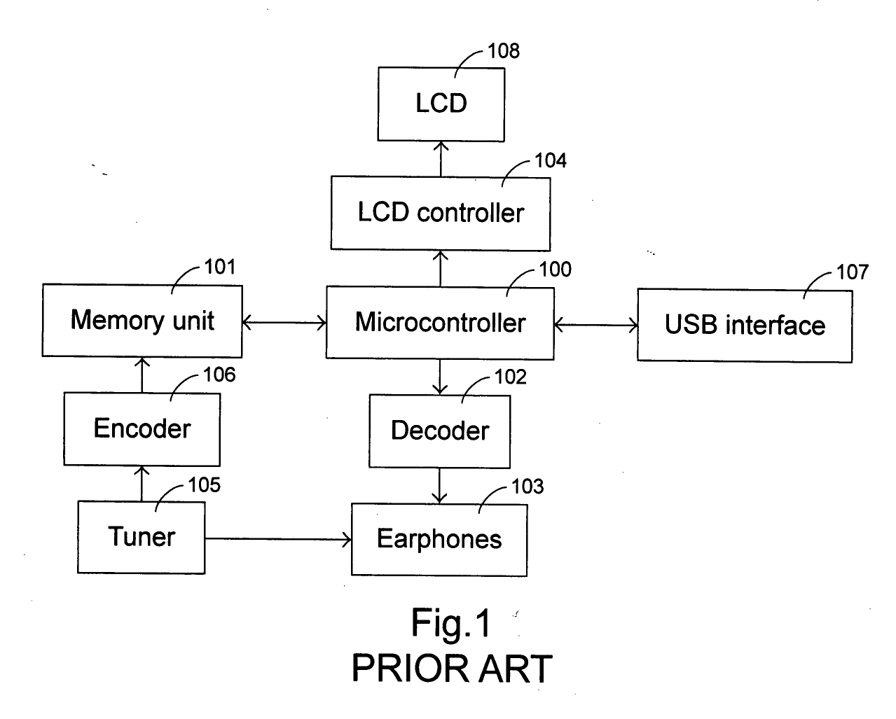

FIG. 2 is a schematic functional block diagram showing an audio player according to the present invention; and

FIG. 3 is a schematic functional block diagram exemplifying the elements included in the main circuit of the audio player of FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

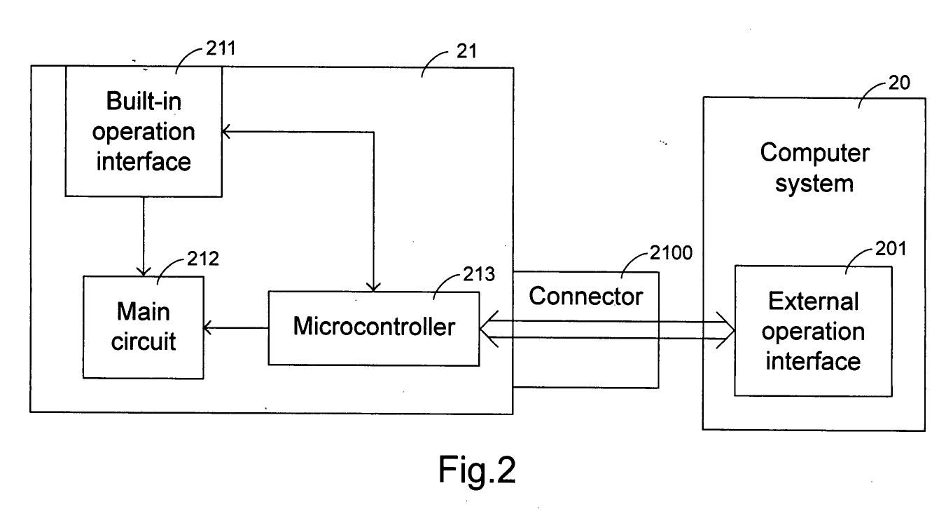

Please refer to FIG. 2. An audio player 21 according to an embodiment of the present invention, when coupled to a computer system 20 via a USB connector 2100, can receive commands from the operation interface 201 of the computer system 20. In other words, in addition to the simplified operation interface 211 originally built in the audio player 21 and consisting of quite limited number of keys, the operation interface 201 of the computer system 20, e.g. mouse, keyboard, etc., can serve as an alternative command source to the audio player 21. It is apparent that a mouse or keyboard in cooperation with the display of the computer system is much more easily and efficiently to input commands and do finely tuning operations than the simplified operation interface and small display of the audio player. The above means can be implemented with a specific control program installed into the computer system and a specifically designed microcontroller 213 of the audio player 21 cooperative with the specific control program to practice the communication. With the specific control program, a graphics interface, for example, can be shown on the display of the computer system, serving as the operation interface 201 to be manipulated by the user, thereby generating corresponding control signals. The control signals are received by the microcontroller 213 under an external bus protocol such as USB protocol or IEEE 1394 protocol, and transmitted to a main circuit 212 of the audio player 21 to be processed. In response to the control signals, various functions could be performed, for example, scanning, searching or memorizing radio channels, recording radio programs, special recording functions such as time shift recording, playing or recording in an audio compressed format such as MP3 or WMA (Windows Media Audio), variably tuning gains of audio signals in different frequency sections such as equalizer function, etc. Of course, the microcontroller 213 also receives control signals generated by the built-in operation interface 211 to perform common functions of the audio player 21.

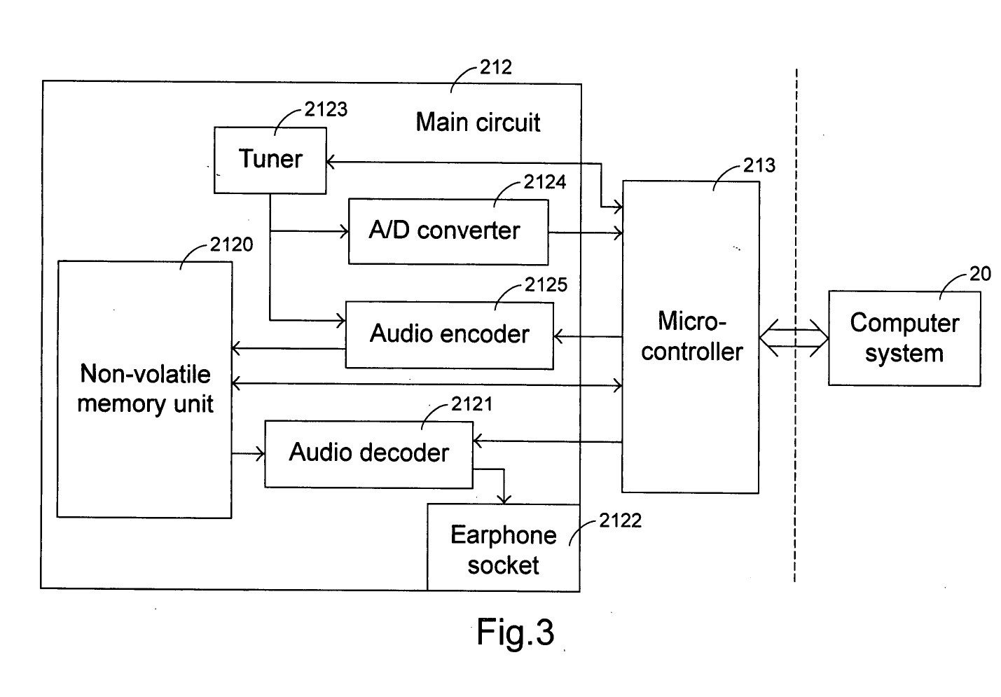

The main circuit 212, as shown in FIG. 3, includes a non-volatile memory unit 2120, an audio decoder 2121, an earphone socket 2122, a tuner 2123, an analog-to-digital converter 2124 and audio encoder 2125. The non-volatile memory unit 2120, e.g. a flash memory, is used for storing digital audio signals of a compressed format such as MP3 or WMA. The audio decoder 2121 coupled to the non-volatile memory unit 2120 may read digital data from the non-volatile memory unit 2120 and outputs the data as analog signals. Via the earphone socket 2122 coupled to the audio decoder 2121, the analog signals may be outputted to earphones in an audible fashion. On the other hand, when the tuner 2123 receives radio signals from a certain channel, the analog audio signals may be transmitted to the audio encoder 2125 to be transformed into a digital audio compressed format such as MP3 or WMA, and then stored into the non-volatile memory unit 2120. Alternatively, the analog audio signals may also be transmitted to the analog-to-digital converter 2124 coupled between the tuner 2123 and the microcontroller 213 to be processed into digital audio signals. The microcontroller 213 may transmit the digital audio signals to the computer system 20 via the USB connector 2100. The digital audio signals then are able to be played by or stored in the computer system 20.

In addition to communicability with the alternative operation interface of the computer system, the audio player according to the present invention may advantageously record radio programs into a memory of the computer system. Accordingly, some complicated functions mentioned above may be performed. For cooperating with the specific control program installed in the computer system to perform these and more functions, the firmware of the microcontroller 213 should be able to execute the following corresponding functions. In response to the control signals from the computer system for performing an equalizer-equivalent function, the microcontroller 213 correspondingly controls the audio decoder 2121 to differentially adjust gains at different frequency sections while playing the audio signals. In another aspect, in response to the control signals from the computer system for a recording function, the microcontroller 213 correspondingly controls the audio encoder 2125 to convert the analog audio signals into digital data and controls the non-volatile memory unit 2120 to store the digital data therein. Further, in response to the control signals from the computer system for dealing with radio channels, the microcontroller 213 correspondingly controls the tuner 2123 to scan, search and/or memorize radio channels. In a further aspect, in response to the control signals from the computer system for outputting previously recorded audio data, the microcontroller 213 correspondingly controls the non-volatile memory unit 2120 to output the audio data therefrom. Still further, in response to the control signals from the computer system for a time shift recording function, the microcontroller 213 correspondingly controls the analog-to-digital converter 2124 to convert the analog audio signals into digital audio signals and controls the transmission of the digital audio signals to the computer system to be stored in a hard disc. The time shift recording function allows the audio signals to be played while they are recorded into the hard disc, and further allows the playing of the audio signals to be interrupted and then played back to a designated time point while the recording of the audio signals into the hard disc still goes on. For example, when a radio program is played and recorded synchronously, the actuation of a time-shift key will enable the control program to lock the audio data currently played while keeping on recording the radio program. Once the time-shift function is de-asserted, the locked audio data can be replayed while the radio program is stilled recorded in a real-time mode.

From the above description, it is understood that the purposes of providing alternative operation interface and expanded functions for an audio player can be achieved by coupling a function-expanded control program to the alternate operation interface and coupling a function-expanded microcontroller to the audio player. The function-expanded control program and the function-expanded microcontroller cooperate with each other to perform various expanded functions that cannot be achieved by currently commercially available small-size audio player, for example, scanning, searching or memorizing radio channels, recording radio programs in a time shift recording mode, variably tuning gains of audio signals in different frequency sections such as equalizer function, etc. Therefore, the audio player according to the present invention is commercially beneficial and particular beneficial when it is a portable audio player that has a limited number of actuation keys and a small display.

While the invention has been described in terms of what is presently considered to be the most practical and preferred embodiments, it is to be understood that the invention needs not be limited to the disclosed embodiment, for example the audio player has not to be a portable audio player or USB-interfaced audio player. On the contrary, it is intended to cover various modifications and similar arrangements included within the spirit and scope of the appended claims which are to be accorded with the broadest interpretation so as to encompass all such modifications and similar structures.

What is claimed is:

1. A portable audio player comprising:
a built-in operation interface for inputting a first command therefrom and generating a first control signal in response to said first command;
a main circuit for processing and optionally storing audio data; and
a microcontroller in communication with said built-in operation interface, said main circuit and an external operation interface for controlling said main circuit to process said audio data optionally in response to said first control signal or a second control signal generated by said external operation interface.

2. The portable audio player according to claim 1 wherein said external operation interface is installed in a computer system.

3. The portable audio player according to claim 2 wherein said external operation interface includes an input interface and a specific control program.

4. The portable audio player according to claim 3 wherein said input interface includes a display of said computer system, a graphics interface shown on said display under the control of said specific control program, and a keyboard or mouse device for manipulating said graphics interface therevia.

5. The portable audio player according to claim 1 wherein said built-in operation interface includes at least one actuation key and a display.

6. The portable audio player according to claim 1 wherein said microcontroller communicates with said external operation interface via a USB interface.

7. The portable audio player according to claim 1 wherein said built-in operation interface, main circuit and microcontroller are integrated to the same housing and optionally connect to said external operation interface via a USB connector.

8. The portable audio player according to claim 1 wherein said main circuit comprises:
a non-volatile memory unit for storing first audio data in a digital form;
an audio decoder coupled to said non-volatile memory unit and said microcontroller for converting said first audio data read from said non-volatile memory unit from said digital form into an audible form under the control of said microcontroller in response to said first or second control signal; and
an earphone socket coupled to said audio decoder for playing said first audio data in said audible form.

9. The portable audio player according to claim 8 wherein said microcontroller controls said audio decoder to differentially adjust gains of said first audio data at different frequency sections in response to said second control signal generated by said external operation interface.

10. The portable audio player according to claim 1 wherein said main circuit comprises:
a tuner for receiving radio signals as second audio data and outputting said second audio data in an analog form; and
an analog-to-digital converter coupled to said tuner and said microcontroller for converting said second audio data received from said tuner from said analog form into a digital form and transmitting said second audio data in said digital form to a computer system to be stored under the control of said microcontroller in response to said first or second control signal.

11. The portable audio player according to claim 10 wherein said microcontroller controls said tuner to scan, search and/or memorize radio channels in response to said second control signal generated by said external operation interface.

12. The portable audio player according to claim 10 wherein said microcontroller controls said analog-to-digital converter to store said second audio data into said computer system in a time-shift recording mode in response to said second control signal generated by said external operation interface.

13. The portable audio player according to claim 12 wherein in said time-shift recording mode, said second audio data are played back to a designated time point that the playing of said second audio data were interrupted while the recording of said second audio data into a hard disc of said computer system are kept in real-time.

14. The portable audio player according to claim 1 wherein said main circuit comprises:
a tuner for receiving radio signals as third audio data and outputting said third audio data in an analog form;
an audio encoder coupled to said tuner and said microcontroller for converting said third audio data from said analog form into a digital form under the control of said microcontroller in response to said first or second control signal; and
a non-volatile memory unit for storing said third audio data in said digital form.

15. The portable audio player according to claim 14 wherein said digital form is a digital audio compressed format.

16. An audio player for use with a computer system, comprising:
a microcontroller communicable with said computer system via a USB interface;
a built-in non-volatile memory unit for storing first audio data in a digital form; and
an audio decoder coupled to said built-in non-volatile memory unit and said microcontroller for converting said first audio data read from said built-in non-volatile memory unit from said digital form into an audible form, and differentially adjusting gains of said first audio data at different frequency sections under the control of said microcontroller in response to a first control signal from said computer system.

17. The audio player according to claim 16 further comprising a tuner for receiving radio signals as second audio data and outputting said second audio data in an analog form, wherein said microcontroller controls said tuner to scan, search and/or memorize radio channels in response to a second control signal from said computer system.

18. The audio player according to claim 17 further comprising an analog-to-digital converter coupled to said tuner and said microcontroller for converting said second audio data received from said tuner from said analog form into a digital form, wherein said microcontroller controls said analog-to-digital converter to store said second audio data in said digital form into said computer system in a time-shift recording mode in response to a third control signal from said computer system.

19. An audio player for use with a computer system, comprising:
a microcontroller communicable with said computer system via a USB interface;
a tuner for receiving radio signals as first audio data and outputting said first audio data in an analog form; and
an analog-to-digital converter coupled to said tuner and said microcontroller for converting said first audio data received from said tuner from said analog form into a digital form and transmitting said first audio data in said digital form to a computer system to be stored under the control of said microcontroller in response to a first control signal.

20. The audio player according to claim 19 further comprising:
an audio encoder coupled to said tuner and said microcontroller for converting said first audio data from said analog form into a digital audio compressed format under the control of said microcontroller in response to a second control signal from said computer system;
a built-in non-volatile memory unit for storing said first audio data in said digital audio compressed format; and
an audio decoder coupled to said built-in non-volatile memory unit and said microcontroller for converting said first audio data read from said built-in non-volatile memory unit from said digital audio compressed format into an audible form, and differentially adjusting gains of said first audio data at different frequency sections under the control of said microcontroller in response to a third control signal from said computer system.
